(19) United States
(12) Patent Application Publication
(10) Pub. No.: US 2004/0126047 A1
(43) Pub. Date: Jul. 1, 2004

(54) Sleeved motor suspension unit

(76) Inventor: Wayne Stuart Mactier, Oatley (AU)

Correspondence Address: BELL, BOYD & LLOYD, LLC, PO BOX 1135, CHICAGO, IL, 60690-1135, US

(21) Appl. No.: 10/471,513

(22) PCT Filed: Mar. 13, 2002
(86) PCT No.: PCT/AU02/00290

(30) Foreign Application Priority Data
Mar. 13, 2001 (AU) PR 3683

(51) Int. Cl. F16C 43/04; F16C 13/00; F16C 35/00

(52) U.S. Cl. 384/584

(57) ABSTRACT

A motor suspension unit for an axle of a railway carriage or locomotive, said unit comprising two bearing mountings located one at each end of a generally U-shaped motor suspension tube, each, of said bearing mountings having an axially aligned cylindrical bearing receiving aperture, an annular shoulder being located at one end of said aperture adjacent said tube and against which a bearing race or bearing cup is intended to abut, an annular groove formed in said aperture and having an axial length less than that of the aperture, a diameter greater than the nominal diameter of the aperture, and also abutting the shoulder, wherein an axially split hollow sleeve having an axial length corresponding to that of said groove is retained in said groove, and the inner surface or said sleeve is machined to said nominal diameter to receive said bearing race or cup and the face surfaces normal to said axle are machined to return same to true.

### FIELD OF THE INVENTION

The present invention relates to railway technology and, in particular, to motor suspension units for the driven axles of railway carriages or locomotives. The motor suspension unit consists of the axle which is to be driven by the motor, a suspension tube and the motor itself. The axle is rotatably held in two bearing mountings located at opposite ends of the U-shaped suspension tube. The electric motor to power the railway carriage or locomotive is mounted on the U-tube and by means of a pinion wheel on the shaft of the motor, drives a gear wheel which is a typically press fitted onto the axle.

### BACKGROUND ART

The U-tube and its associated bearing mountings are subject to various significant forces in use since the motor is relatively heavy and constitutes an unsprung mass. In order to reduce the unsprung mass the U-tube is made as light as possible.

In order to carry out servicing of the motor suspension unit, it is often necessary to remove press fitted items, such as the gear wheel, and in so doing the U-tube and its associated bearing mnountings are liable to be bent. These items are also liable to be bent during use so it is uncertain as to the exact cause of the bending. However, the result is the two bearing mountings at opposite ends of the U-tube are no longer true and this creates significant wear and other problems.

One means of returning the U-tube to true is to press the metal back into shape which requires very elaborate and specialised machinery. Another solution is to apply additional material to the bearing mountings, such as by welding or by metal coating, or similar, and then re-machining the both bearing mountings so that they again fall within the tolerances to either side of the nominal dimensions. There is a fear that such activities, and especially the application of heat, may detract from metallurgical properties of the U-tubed as originally manufactured. Since such U-tubes are known to be highly stressed elements of the motor suspension unit, such activities which may damage the metallurgical properties of the components are contra-indicated.

### OBJECT OF THE INVENTION

The aim of the present invention is to attempt to ameliorate some of the abovementioned difficulties by the provision of a method and apparatus whereby the U-tube and its bearing mountings can be substantially returned to true after being bent.

### SUMMARY OF THE INVENTION

According to the first aspect of the present invention there is disclosed a motor suspension unit for an axle of a railway carriage or locomotive, said unit comprising two bearing mountings located one at each end of a generally u-shaped motor suspension tube, each of said bearing mountings having an axially aligned cylindrical bearing receiving aperture, an annular shoulder being located at one end of said aperture adjacent said tube and against which a bearing race or bearing cup is intended to abut, an annular groove formed in said aperture and having an axial length less than that of said aperture, a diameter greater than the nominal diameter of said aperture, and also abutting said shoulder, wherein an axially split hollow sleeve having an axial length corresponding to that of said groove is retained in said groove, and the inner surface of said sleeve is machined to said nominal bearing diameter to receive said bearing race or bearing cup and the face surfaces normal to said axle are machined to return same to true.

According to the second aspect of the present invention there is disclosed a method of returning to true the bearing arrangements of a motor suspension unit comprising two bearing mountings located one at each end of a generally u-shaped motor suspension tube, each of said bearings mountings having an axially aligned cylindrical bearing receiving aperture having an annular bearing abutting shoulder adjacent said tube, said method comprising the steps of:—

(a) machining each said aperture to create an annular groove therein having an axial length less than that of said aperture, a diameter greater than the nominal diameter of said bearing, and also abutting said shoulder,

(b) introducing into each said aperture an axially split hollow sleeve having an axial length corresponding to that of said groove by circumferentially compressing said sleeve,

(c) aligning said compressed sleeve with said groove,

(d) releasing said circumferential compression of said sleeve to retain said sleeve in said groove, and

(e) machining both the inner surface of said sleeve to said nominal bearing diameter, and the face surfaces of said bearing mountings normal to the axle to return said face surfaces to true.

### BRIEF DESCRIPTION OF THE DRAWINGS

A preferred embodiment of the present invention will now be described with reference to the drawings in which:

FIG. 1 is an exploded perspective view of a prior art motor suspension unit taken from a General Electric publication,

FIG. 2 is a side elevational view taken from the same publication and showing details of the bearing mountings at both the commutator end and the pinion end of the axle,

FIGS. 3 and 4 are enlargements of the pinion end and commutator end respectively shown in FIG. 2,

FIGS. 5 and 6 are views of the U-tube and bearing housing of FIGS. 3 and 4 respectively but modified in accordance with the preferred embodiment of the present invention,

FIG. 7 duplicates FIG. 2 of Australian Patent No. 682,575, and

FIG. 8 is a view similar to FIG. 6 but of an alternative arrangement.

### DETAILED DESCRIPTION

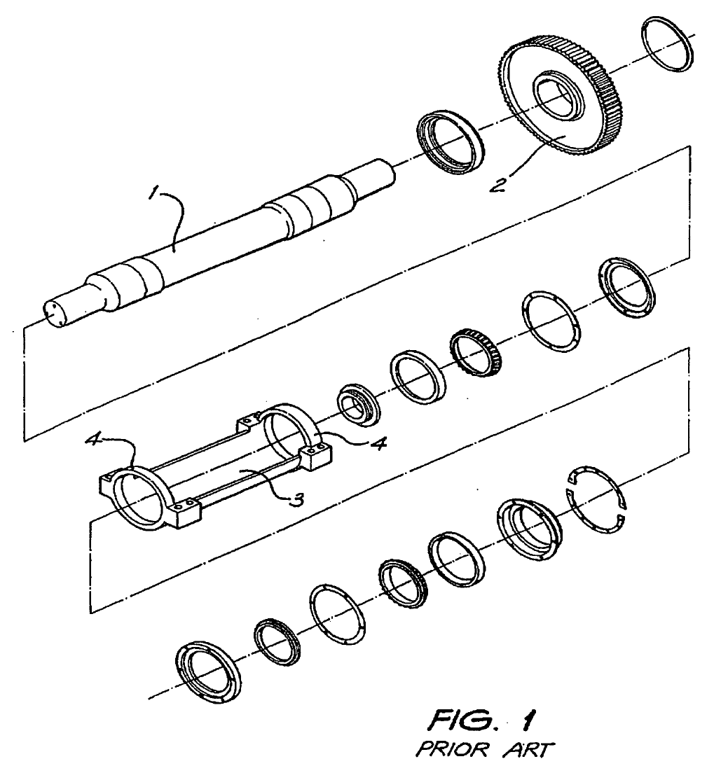

As seen in FIG. 1, the motor suspension unit takes the form of an axle 1 on which is pressed a gear wheel 2, the axle 1 being suspended within a U-tube 3 having a bearing mounting 4 at each end thereof. The U-tube 3 is typically approximately one metre in length and supports the electric motor (not illustrated) which powers the railway carriage or locomotive. With reference to the electric motor, opposite ends of the arrangement are referred to as the commutator end and the pinion end.

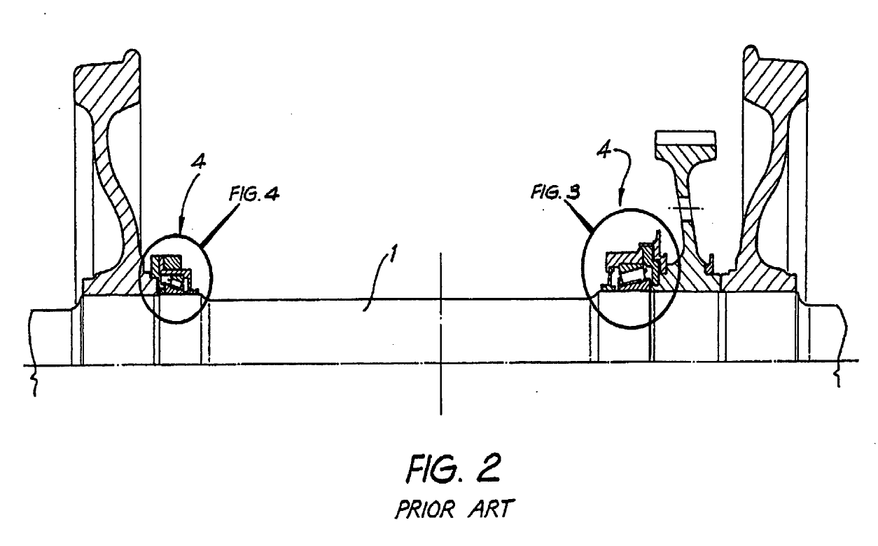

The detail of the bearing mountings at the pinion and commutator end are illustrated in FIG. 2 and also illustrated to a larger scale in FIGS. 3 and 4 respectively. In both instances the philosophy is similar although the detail of the execution is different.

At the pinion end, the bearing 6 is positioned between the axle 1 and the U-tube bearing mounting 4. At the commutator end, the bearing 6 is interposed between the axle 1 as before and a bearing housing 7 which in turn bears upon the U-tube bearing mounting 4.

It will be apparent from FIGS. 3 and 4 that the U-tube bearing mountings 4 and bearing housings 7 are relatively thin compared to the substantial size of the axle 1 and are thus liable to bend either during use or during servicing. Whatever the cause of the bending, when such a bend arises, the bearing 6 is no longer true to the longitudinal axis of the axle 1 and therefore substantial wear can rapidly take place. This is in addition to the normal wear which can occur even if the bearings and their mountings remain true.

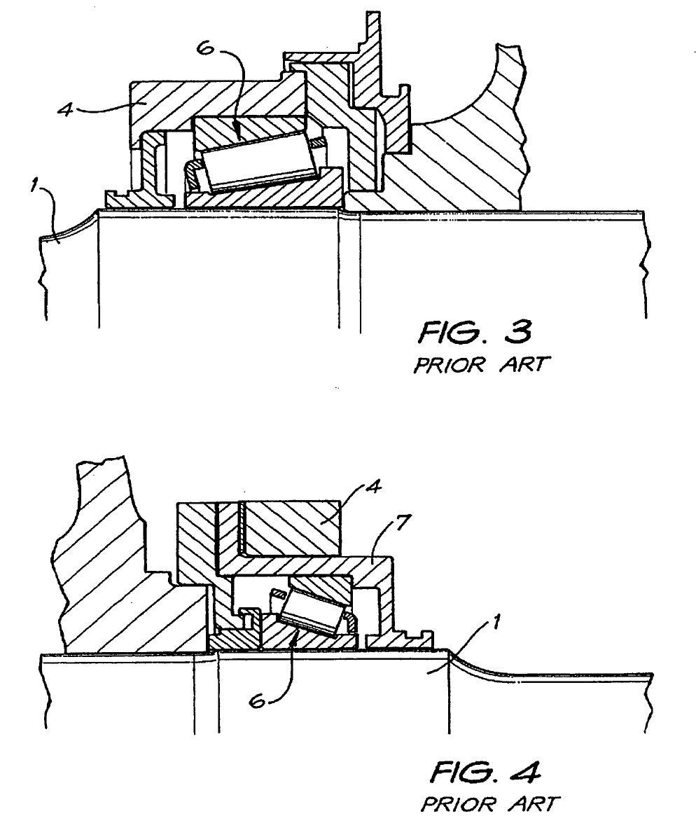

Turning now to FIG. 5, for the bearing mounting 4, it will be seen that there is a cylindrical bearing receiving aperture 10 which has an annular shoulder 11. In addition, the bearing mounting 4 also has a front face 12. An indication as to how the front face 12 and the shoulder 11 can be bent out of a plane perpendicular to the longitudinal axis of the axle 1 is provided by means of dashed lines in FIG. 5.

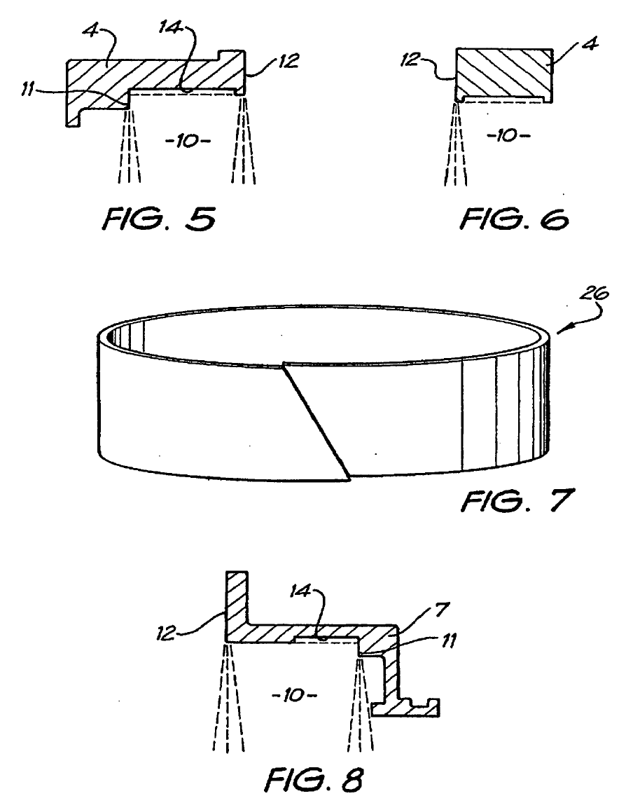

Rather than attempt to bend the bearing mountings 4 in order to return same to true, in accordance with the preferred embodiment of the present invention it is proposed to machine an annular groove 14 so as to remove only a very small amount of metal from the bearing mounting 4. Thereafter an axially slit support sleeve 26 (FIG. 7) of the type illustrated in FIG. 2 of Australian Patent No. 682,575 (WO95/23927) is inserted in the groove 14. Preferably the sleeve 26 is glued into position with LOCTITE (Registered Trade Mark) adhesive, or similar. Such a support sleeve 26 is able to be machined in the manner disclosed in the abovementioned patent so as to return the bearing receiving aperture 10 to its nominal size thereby permitting the bearing 6 to be reinserted in the aperture 10 and overcoming any problem with wear of the bearing receiving aperture 10.

Similarly, with reference to FIG. 6, the u-tube or bearing mounting 4 can be machined to be provided with an annular groove 14. Again the front face 12 of the bearing mounting 4 of FIG. 6 will also be out of alignment because of the bending of the u-tube 3. The nature of the misalignment is indicated by dashed lines in FIG. 6.

Alternatively, as illustrated in FIG. 8, at the commutator end illustrated in FIG. 4, the bearing housing 7 with its shoulder 11 and front face 12 can also be machined to provide the necessary groove 14.

However, most importantly, the abovementioned machining operation can also be extended to machine the front faces 12 and the shoulder 11 in a simultaneous operation which machines both the bearing receiving apertures 10 of the U-tube 3 and also machines all front faces 12 and shoulder 11. In this way the front faces 12, shoulders 11 and bearing receiving apertures 10 can all simultaneously be returned to true relative to the longitudinal axis of the axle 1 in a single machining operation.

In this connection it will be appreciated that the diameter of the bearing receiving aperture 10 is critical since it must be a tight fit on the axle 1 and must also be centred relative to the longitudinal axis of the axle 1. Thus it is necessary to return any material which has been worn away and this is provided by the axially split support sleeve 26.

However, it is not critical to return material which is machined from the shoulders 11 and front faces 12 since the loss of this material (typically 5-10 thousands of an inch) merely changes the spacing of the railway wheels by this small amount. This is thought to be such a minute change that no action is required. However, if desired, the loss of material due to the machining of the front faces 12 can be made up by use of annular spacers or shims (not illustrated but well known in the art).

Industrial Application

It will be appreciated by those skilled in the art, that the abovementioned patent deals with axle boxes that are located at opposite ends of the axle 1 of FIGS. 1 and 2 whereas the present invention deals with the support tube 3 which is positioned centrally on the axle 1. There is no critical need for the bearing receiving apertures of the axle boxes to be longitudinally aligned and true relative to the longitudinal axis for the axle. Indeed, the axle boxes at opposite ends of the axle are often unintentionally out of alignment by as much as a quarter of an inch, without serious consequences arising. The only consequence is that the carriage is tilted slightly or the misalignment is absorbed by the suspension. However, in the case of the motor suspension unit, and the U-tube 3 in particular, it is essential that the two bearing mountings 4 be coaxial with each other, and with the longitudinal axis of the axle 1. It is also essential that the front faces 12 be perpendicular to the longitudinal axis of the axle 1. It will be appreciated that the adaptation of the previously known method allows both bearing receiving apertures 10 and all front faces 12 and shoulders 11 to be simultaneously machined in a single operation. This thereby ready provides, at a low cost, the desired final outcome.

The foregoing describes only one embodiment of the present invention and modifications, obvious to those skilled in the art, can be made thereto without departing from the scope of the present invention. For example, in some types of motor suspension unit, the annular shoulder 11 is not present and instead the bearing includes an annular flange which abuts the front face 12 to achieve the same object.

The term “comprising” as used herein is used in the inclusive sense of “having” or “including” and not in the exclusive sense of “consisting only of”.

1. A motor suspension unit for an axle of a railway carriage or locomotive, said unit comprising two bearing mountings located one at each end of a generally u-shaped motor suspension tube, each of said bearing mountings having an axially aligned cylindrical bearing receiving aperture, an annular shoulder being located at one end of said aperture adjacent said tube and against which a bearing race or bearing cup is intended to abut, an annular groove formed in said aperture and having an axial length less than that of said aperture, a diameter greater than the nominal diameter of said aperture, and also abutting said shoulder, wherein an axially split hollow sleeve having an axial length corresponding to that of said groove is retained in said groove, and the inner surface of said sleeve is machined to said nominal bearing diameter to receive said bearing race or bearing cup and the face surfaces normal to said axle are machined to return same to true.

2. The unit as claimed in claim 1 and having a bearing retained within each said sleeve.

3. The unit as claimed in claim 1 or 2 wherein said sleeve is glued to said groove.

4. A modification to the unit claimed in any one of claims 1-3 wherein said annular shoulder is not present and said bearing race or cup Includes an annular flange.

5. A method of returning to true the bearing arrangements of a motor suspension unit comprising two bearing mountings located one at each end of a generally u-shaped motor suspension tube, each of said bearings mountings having an axially aligned cylindrical bearing receiving aperture having an annular bearing abutting shoulder adjacent said tube, said method comprising the steps of:—
(a) machining each said aperture to create an annular groove therein having an axial length less than that of said aperture, a diameter greater than the nominal diameter of said bearing, and also abutting said shoulder,
(b) introducing into each said aperture an axially split hollow sleeve having an axial length corresponding to that of said groove by circumferentially compressing said sleeve,
(c) aligning said compressed sleeve with said groove,
(d) releasing said circumferential compression of said sleeve to retain said sleeve in said groove, and
(e) machining both the inner surface of said sleeve to said nominal bearing diameter, and the face surfaces of said bearing mountings normal to the axle to return said face surfaces to true.

6. The method as claimed in claim 4 and including the step of:—
(f) adhering said split sleeve within said groove.

7. The method as claimed in claim 4 or 5 and including the step of:—
(g) inserting a bearing into each said sleeve.

8. A modification to the method claimed in any one of claims 5-7 wherein said annular shoulder is not present and said bearing includes an annular flange.
